(19) United States
(12) Patent Application Publication
(10) Pub. No.: US 2025/0129261 A1
(43) Pub. Date: Apr. 24, 2025

(54) Material and System for Minimizing Light Refraction in Glass Crack Repair

(71) Applicant: Shiloh Spoo, Bend, OR (US)

(72) Inventor: Shiloh Spoo, Bend, OR (US)

(21) Appl. No.: 18/827,543

(22) Filed: Sep. 6, 2024

Related U.S. Application Data
(60) Provisional application No. 63/536,872, filed on Sep. 6, 2023.

(51) Int. Cl. C09D 133/10; C03C 27/10; C09D 4/00; C09D 7/61; C09D 133/02; C09D 133/08

(52) U.S. Cl. CPC C09D 133/10; C03C 27/10; C09D 4/00; C09D 7/61; C09D 133/02; C09D 133/08

(57) ABSTRACT

A glass repair resin which is light curable is provided which will significantly reduce or eliminate errant reflections from crack surfaces within a defect in glass such as a windshield. The light-curable resin has a quantity of particles mixed therein in a liquid solution. The liquid solution is positionable into an injector whereby the glass repair resin is injected into a glass defect. The injected solution, once cured, forms a solid solution of resin and disbursed particulate which acts to block sunlight reflections from crack surfaces within the defect.

This application claims priority to U.S. Provisional patent application Ser. No. 63/536,872 filed on Sep. 6, 2023.

### BACKGROUND OF THE INVENTION

### 1. Field of the Invention

The present invention relates generally to the repair of cracks formed in glass and laminated glass products. More particularly, the invention relates to a curable material formulation and curing system for resins which can be employed to repair glass cracks and defects.

### 2. Prior Art

Glass is widely employed throughout the world to provide a barrier through which a viewable area on one side of the glass panel can be viewed by a person on an opposite side of the glass sheet. Such glass panels are employed in the windows and doors of buildings and in a laminated configuration in vehicles.

Laminated glass consists generally of a plurality of layers of glass material having one or a plurality of layers of a tough polymeric material or resin operatively engaged thereto. When such laminated glass is impacted by an object and/or broken by impacts or the like, defects and cracks are formed into the glass sheet.

During manufacture, a thin layer of plastic is sandwiched between two layers of glass. These two glass layers are bonded together by forming a permanent flexible attachment to the plastic in an autoclave using heat and pressure. Conventionally, the plastic layer is usually polyvinyl butyral (PVB). However, other plastic or polymeric material is used. Thus, the interlayer of plastic material sandwiched between the glass layers maintains the layers of glass bonded even when broken or cracked and tends to limit breakage and cracking as well as preventing glass shards from detaching from the structure.

Such laminated glass is normally used when there is a possibility of human impact or where the glass could fall and shatter or where it is subject to shattering when adjacent to people. Skylight glazing and automobile windshields typically use laminated glass. In geographical areas requiring hurricane-resistant construction, laminated glass is often employed in windows on exterior storefronts, curtain walls, and windows.

Laminated type glass sheeting is widely employed in vehicle windows known as windshields and wind screens. Both the side windows and front and rear windshields are formed conventionally in this type of laminated glass construction and are probably one of the most common conventional forms of laminated glass.

It should be noted that when referred to herein, laminated glass may be referred to as a windshield, windscreen or pane or a sheet for ease of description and convenience. A reference to laminated glass will also apply to any type of glass having such a laminated construction.

As previously mentioned, laminated glass, such as a windshield for a vehicle, is commonly constructed of two glass layers and an intermediate layer of tough plastic. For safety reasons for occupants, a similar configuration is employed in building windows. However, such may also have exterior polymer sheeting.

When a conventional vehicle windshield, formed of such laminated glass, suffers an impact at a surface point, a break in the uniform clear glass structure is usually formed. Such breaks frequently take the form of a bullseye or a star having radially projecting cracks. While such breaks can initially have small cracks radiating from a point which is open on the surface outwardly and downwardly through the outer lamination of the resin interface, where laminated glass is impacted to form a small bullseye or a star without further cracking across the entire pane or windshield, there continues an ongoing risk of a large crack developing from the initial impact point.

When such damage occurs to a vehicle windshield or similar laminated glass panel, various contaminants including air and moisture may become trapped between the two layers of glass. These contaminants can alter the refractive index of the windshield thereby obscuring or impeding the vision of a driver. Also, these damages will weaken the windshield compromising the structural integrity of the windshield and its ability to properly support the structure of the vehicle.

Differing methods and devices have been developed over many years which enable such small impact craters and cracks to be repaired. Such repairs produce, generally, a substantially clear or transparent viewing through the cured material, such as a cured resin, which is first forced into the impacted area of the glass. The resin is injected or forced into the voids in a liquid form and, once cured using UV light or heat or other accelerated curing means, also provides an adherence of the cured resin to both sides of the glass material forming a crack which helps prevent longer cracks from developing across the pane or windshield.

However, such cured resin material, conventionally, has a different index of refraction for light passing through it from that of the surrounding glass. Also, in many cases where a windshield break or an irregular window crack has been repaired using a cured resin, incoming light is diffused by the cured resin differently than that of the surrounding glass. The light will, thus, tend to exit the repaired glass sheet at differing refracted angles.

Where such light refraction and reflection occurs on a vehicle windshield, for example, it can cause light reflections from one or both opposing sides of the repaired crack or defect through the cured resin. The cured resin itself within a crack or defect can cause the projection of light rays from the repaired crack area at numerous angles. Depending on the position of the sun and the incoming angle of light, the reflected light from the repaired crack or break can easily be directed toward the eyes of the driver or passengers in the vehicle or toward the heads up display on the windshield. Such can be both distracting to the driver and irritating to both the passenger and driver over time, especially on a day with bright sunlight.

The forgoing examples of related art, as to reflected light from the areas of cured resin positioned into cracks and impact areas of laminated glass, and the limitations related therewith, are intended to be illustrative and not exclusive, and they do not imply any limitations on the invention described and claimed herein. Various other limitations in the related art of laminated glass repair will become apparent to those skilled in the art upon a reading and understanding of the specification below and the accompanying drawings.

### SUMMARY OF THE INVENTION

The resin and accelerated curing method and resin mixture enabling the system herein disclosed and described provides significant improvement in both the amount and angles of reflected light emitted from repaired cracks and impact areas of conventional laminated glass for vehicles. Windshield repair resin, which is widely used, is conventionally made from acrylic acid, an organic compound which is also used in polishes, adhesives, and coatings. Some other ingredients in windshield repair resin may include photo initiators which trigger the curing process when exposed to light energy, monomers which affect the degree of adhesion to the glass, and oligomers which provide mechanical properties, such as strength, hardness, and elasticity.

By resin herein is meant any resin material employable for glass repair which may be cured in an accelerated time duration, such as optically cured (UV) and/or catalyst-hardened resins which are injected under pressure into the voids forming cracks and glass defects in laminated glass. As an example of such resin material and in no way limiting, are resin materials from a group including, Benzyl Methacrylate, 2-Hydroxyethyl methacrylate, Octyl Acrylate, Decyl Acrylate, Acrylic Acid, and Isobornyl Acrylate.

Conventionally, the user, employing a resin injector to repair such a crack or glass defect, will choose a particular resin from a number available, based on the type of glass being repaired, and/or the type and size of the defect therein, the temperature proximate to the glass, and a desired viscosity based on the crack to be repaired. The user must then determine a cure time for the injected resin, and thereafter, employ a light emitter with the correct light emissions range to cure the resin. Once cured, the visual disturbance caused by the void between two sides of the crack or other defect in the glass is significantly reduced. However, as noted, the resin itself, so cured and positioned within the voids forming the cracks or other visual defects can also cause light emissions at multiple angles which can at best be annoying to the driver and passengers in the vehicle.

The resin system herein thus allows for widespread use in a variety of different and widely employed resin injection systems for glass repair with virtually no modification to the currently used resin injectors and conventional curing times and types. The mixture of material herein of a light curable resin and a nonsoluble particulate material, as herein disclosed, once the light curable resin is cured to form a solid solution of resin and particles in fixed but disbursed positions therein, will significantly reduce the angular disbursement and amount of light reflected from repaired cracks. Such will significantly reduce errant light reflections from the repair area into the eyes of drivers and passengers alike.

Additionally in experimentation it was found that during the method of repairing a glass defect with the light curable resin herein, the inclusion of a vibrating attachment which is operatively engaged to the resin injector or the glass or a curing light, can also improve the repair provided by cured resin being injected into a glass defect. This vibrating attachment, using an onboard power source, such as a battery, and a vibrating component, such as an unbalanced motor or other electric powered vibrating components, communicates a vibration into the resin injector. Preferably, the vibration is communicated into the injector at a position adjacent the injection site on the glass.

This inclusion of the vibrating attachment has been found to improve the flow of resin into the crack or defect where any type of injectable curable resin is employed. Where the resin containing particles herein disclosed is employed, the resin will flow better into smaller areas of the glass crack or defect. The vibration works best when it is concurrently imparted to both the glass being repaired and the injector nozzle. During the process of the repair, the vibration operates to also maintain the nano or micro sized particles more evenly disbursed through the resin during the injection process until the resin cures, as well as to dislodge air bubbles from the area to be repaired during a suction step to remove air. In this fashion, the particles can be maintained evenly disbursed within the uncured resin and remain so once the resin is cured to a solid solution of cured resin and particles. Currently, experimentation has shown that non dissolving particles included in the resin in a range of size from 0.1 microns to 100 microns works well to help eliminate or significantly reduce the brightness of divergent reflections from the surfaces of the cracks without making the repair so dark as to be a dark spot on the windshield. Currently, particles in a range of 1 to 50 microns have been found to have the widest ability for use in the different types and viscosities of resin used.

The resin herein which, once cured to a solid solution of resin and particles, will serve to eliminate or significantly reduce errant light refraction and light reflection emissions from the repair site since it preferably includes particulate or solid particles which will not dissolve in the resin into which it is included. Once the resin hardens through curing, using UV light or other curing means, the solid solution is formed of cured resin having disbursed solid particles held in position throughout to form a pseudo polarizing layer.

Currently, by particulate or particles herein is meant material particles which will not dissolve within the light curable resin into which they are mixed, and which will form a solid solution of light curable resin and disbursed particles therein, and once the light curable resin is cured, will form a solid solution of cured resin and disbursed particles. Examples of such particles to be employed with the light curable resin to form the solid solution thereof, and in no way limiting, are particle types from a group of particle types including graphene, carbon, carbon black, graphite, ceramics, and/or a blend of one of more of the particles from this group. Other particulate material may also be employed so long as it does not dissolve in the liquid resin. Preferably, as noted, the particles employed are formed with jagged perimeter edges surrounding the particle body.

The inclusion of the above particles has other benefits. Graphene is a strengthening agent to the overall strength of the cured resin. Graphite and ceramic materials can provide a reduction of heat. Thus, the inclusion of the noted particles, alone or in combination, can provide a stronger and more weather resistant repair in the solid solution formed in the combination with the cured resin.

In the mixture of a light-curable resin and particles or particulate herein is meant a light curable resin material which includes a particulate material in a ratio of 0.04 to 20% of particulate material by total volume of combined light-curable resin and particulate material. By light-curable resin material employed in combination with the particles noted herein is meant one or a combination of light-curable resins from a group including, Benzyl Methacrylate, 2-Hydroxyethyl methacrylate, Octyl Acrylate, Decyl Acrylate, Acrylic Acid, and Isobornyl Acrylate. Of course, other light-curable resins employed to repair glass, such as windshields, as would occur to those skilled in the art or that becomes commercially available, are also anticipated for use and to be included in this application as light-curable resin. However, the group above is currently favored due to availability.

The above noted mixture ratio, once light-cured, has been found to form the solid solution of a cured resin and disbursed particles which will significantly reduce reflected light and light emissions at disparate angles from the repaired area. The particles of material suspended in the solid solution of cured resin and particles operate in a manner to form a light polarizer within the cured resin material. This is because the particles suspended in the solid solution of a cured resin and particles blocks light waves moving through the solid solution which are emitted in a sideways or tangent direction from that of incoming light, or in reflections from the surfaces within the repair area which frequently occur in repairs lacking the inclusion of cured resin with such particles.

With respect to the above description, before explaining at least one preferred embodiment of the herein disclosed resin curing material and method invention in detail, it is to be understood that it is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other resin and particulate mixtures which once cured into a glass defect area will serve to reduce errant light emissions therefrom. It is important, therefore, that the claims be regarded as including such equivalent construction and methodology insofar as they do not depart from the spirit and scope of the present invention.

It is an object of this invention to provide a curable resin for repair of cracks and other defects in plain glass or laminated glass which will minimize angled light reflections and errant light reflections from the cured resin in the repair area.

It is a further object of this invention to provide a curable resin for glass defect repair which operates in a manner similar to a polarizer by blocking portions of reflected light from repaired surfaces of the glass as well as from light transmitted through and refracted by the cured resin.

It is an object of this invention to provide a method for repairing defects, such as cracks, formed in glass using a light curable resin mixed with suspended particles which will cure to form a solid solution which blocks or inhibits light reflection therethrough.

The objects, features, and advantages of the present invention, as well as the advantages thereof over existing prior art, which will become apparent from the description to follow, are accomplished by the improvements described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures herein are to be considered illustrative of the curable resin mixture and method herein, rather than limiting.

In the drawings:

FIG. 1 depicts a conventional resin injector in an as-used positioning for injecting a light curable resin in liquid form into a crack or defect area in glass, such as a vehicle windshield.

FIG. 2 depicts a sectional area of light cured resin material widely employed in the repair of glass.

FIG. 3 shows the light curable resin herein formed to a solid solution of particles and cured resin.

FIG. 3A depicts light curable resin employed in the device and method herein showing particles disbursed therein which have jagged edges.

FIG. 4 shows an injector for resin into the glass defect, as in FIG. 1, and also depicts a vibrating component operatively connected to the body of the injector to enhance resin injection and mixing.

FIG. 5 is a depiction of a typical windshield having a defect formed therein for that this device and method herein is employable to repair.

FIG. 6 is a graphic depiction of a conventional vehicle having sunlight communicating through a glass defect in a windshield which has not been repaired.

FIG. 7 shows the windshield, as in FIG. 6.

FIG. 8 shows the vehicle, as in FIG. 6, wherein the windshield is either undamaged or has had the glass defect repaired using the device and method herein wherein stray light refractions and reflections have been significantly reduced.

FIG. 9 depicts a windshield, as in FIG. 8, wherein the defect has been repaired with the solid solution of light curable resin and particles herein.

FIG. 10 depicts the injector for resin with the stand portion removed for clarity showing a vibrating component which concurrently communicates a vibration to both posts in contact with the windshield and to the body of the injector.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer depictions as they are oriented and appear in the drawings and are used for convenience only and they are not intended to be limiting or to imply that the device or components thereof have to be used or positioned in any particular orientation.

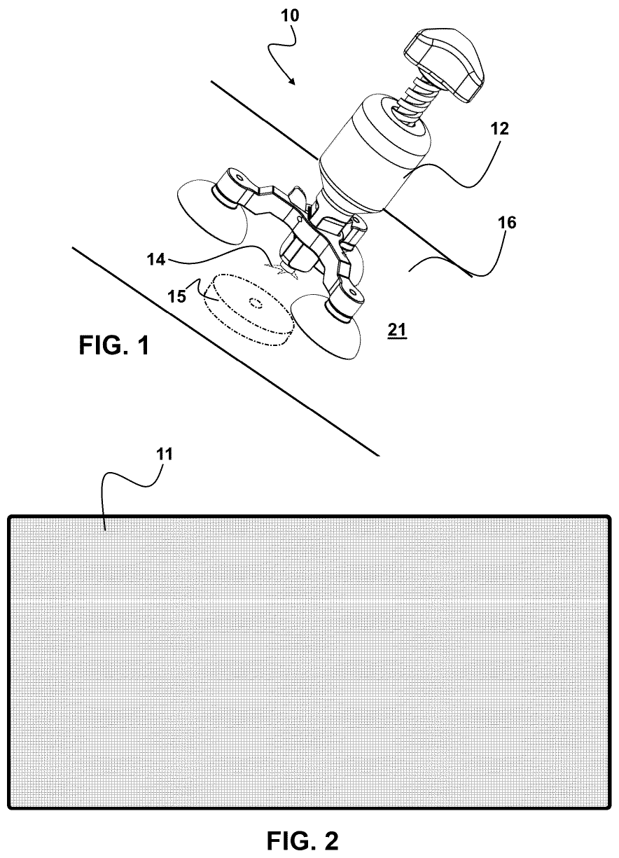

Now referring to drawings in FIGS. 1-10, wherein similar components of the system 10 herein are identified by like reference numerals. There can be seen in FIG. 1 a prior art or conventional resin injector 12 which is widely employed to inject a liquid resin 11 into a glass defect 14, such as a crack or star or the like, in a sheet of glass 16, such as a vehicle windshield, as also shown in FIG. 5. Conventionally, such injectors 12 form a seal on a dispensing end thereof with the surface of the glass 16 over the area of the defect 14. Professional grade injectors 12 operate to first pull the air and moisture from the area in the glass of the defect 14, and in a second step, thereafter, communicate the resin into it.

Once the resin 11 is communicated into the void of the defect in the glass 16, a curing light 15, which is usually in the UV spectrum, is employed. This curing light 15 communicates light to the injected resin causing it to harden to a solid solution. As noted, the cured resin 11 will have an index of refraction which is different from that of the surrounding glass 16 but not so different as to cause reflected light at divergent angles to that passing through the glass 16. Additionally, where the defect 14 includes cracks into the sheet of glass 16, the side surfaces of such cracks can operate somewhat like mirrors to reflect incoming light communicating through the glass 16 at divergent angles.

FIG. 2 shows a cross section example of conventional cured resin used in defect 14 repairs. As shown such resins 11 by design have minimal or no particulate within the resin 11 material once cured. As such where used in a conventional fashion to repair the defects 14 within a sheet of glass 16, such conventional resins 11 allow light waves to transmit therethrough in any direction in an uninterrupted manner. This allows incoming light which strikes a planar crack surface, to reflect

According to the law of reflection, light is always reflected at the same angle of incidence at which it arrives at a surface. In other words, when light comes into contact with a reflecting surface, the angle of reflection equals the angle of incidence. Thus, where a defect 14 has a crack running at an angle to the planar sides of a glass sheet and light hits that reflecting surface, it will reflect at angles equal to that at which the light hits. Where such cracks in a defect 14 run perpendicular or at angles that are not parallel to the front and rear surfaces of a windshield, the light hitting the surface of such cracks reflects toward the head of the driver and the head of the passenger which is at best irritating.

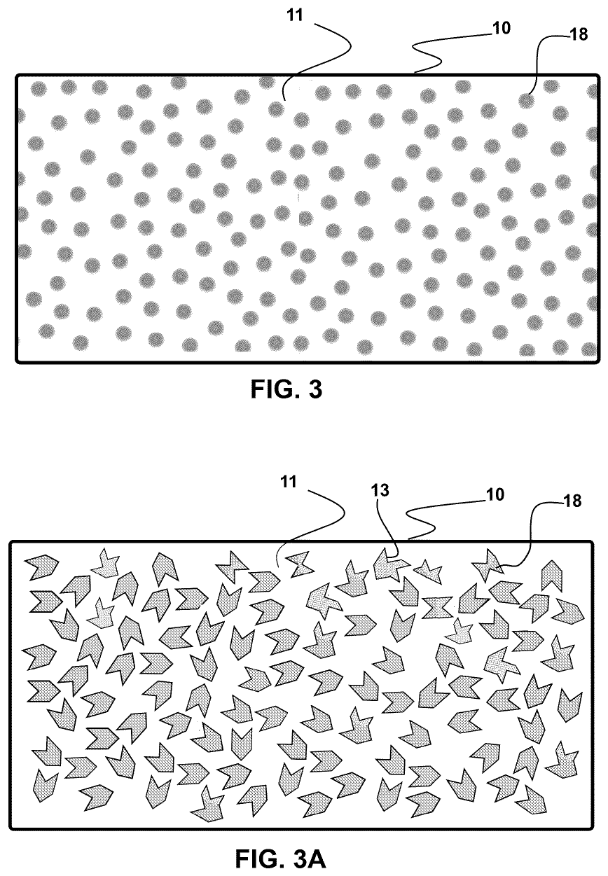

Shown in FIG. 3 is a graphic depiction of the curable resin 11 herein. As shown, the curable resin 11 in FIG. 3, once cured, will form a solid solution of hardened resin material with particles 18 disbursed throughout. These particles 18, as noted, are formed of material which will not dissolve in the resin 11 when it is in a liquid form and thus are held in position, once the resin 11 has cured. As can be discerned, the particles 18 disbursed throughout the cured resin 11 material herein will form barriers to light reflecting from cracks and angular recesses of defects 14 which might be reflected from these reflecting crack surfaces or otherwise placed in a divergent path from that of incoming light to the glass 16. The particles 18, so suspended in the solid solution and formed of material to block passage of light therethrough, will thus significantly reduce or block light which reflects at an angle which is not normal or substantially perpendicular to the smooth exterior and interior surfaces of the sheet of glass 16.

As noted, currently, a preferred mixture of curable resin 11 and particles 18 therein, forming the curable resin material for injection by the injector 12, will have the particulate material in a ratio of 0.04 to 15% of particulate 18 by total volume of the mixture of particulate 18 and curable resin 11 material. The particles or particulate 18 is composed of material which will not dissolve in the liquid resin and which is non-reactive with the resin 11 either in liquid form or cured and where the particles 18 will block light transmission. Favored particulate material, currently, includes particulate 18 or particles from a group of particulates 18 including carbon, carbon black, graphite, ceramics, graphene individually or in a blend of one of more of the particles from this group.

In another view, shown in FIG. 3A of the light curable resin 11 employed in the device and method herein, the particles 18 used have uneven or jagged edges 13. The shape shown is, for example, only and not limiting as the jagged edges 13 can be any non smooth edge which changes angles multiple times around the parameter edge of each particle 18.

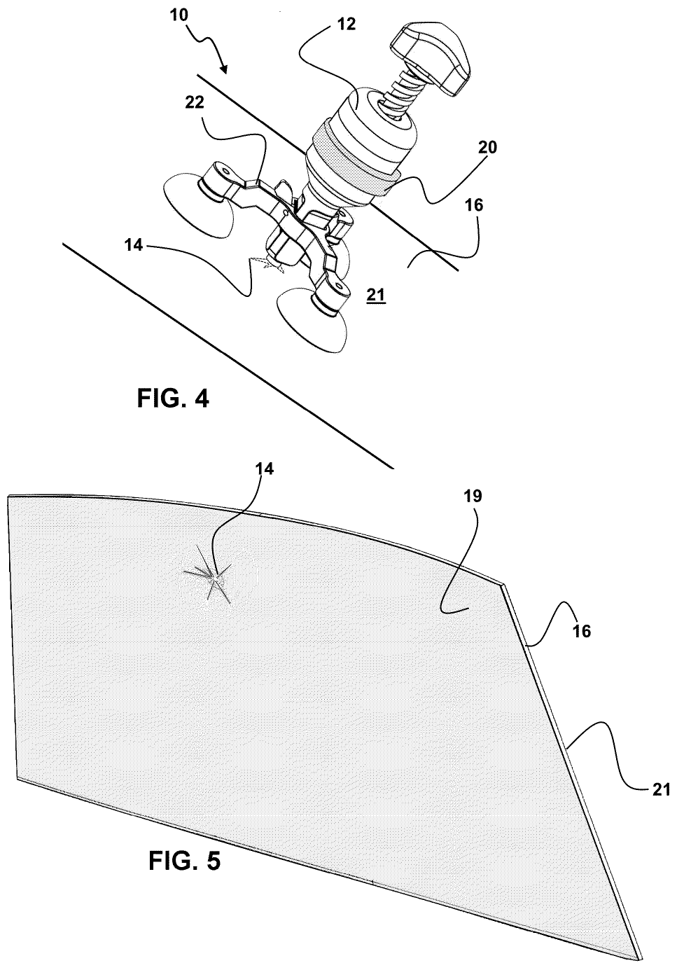

In FIG. 4 is depicted a conventional injector 12, such as shown in FIG. 1, wherein a vibrating component 20 has been operatively engaged to the injector 12. The vibrating component 20 may be operatively connected to the body of the injector 12 which is held in place by a stand 22. This attachment position has shown in experimentation to communicate vibrations generated by the vibrating component 20 axially down the body 20 and to the glass 16. However the vibrating component 20 may also be engaged to the stand 22 and communicate vibrations to the body of the injector 12. By vibrating component 20 herein is meant any electric powered vibration motor in a size and configuration adapted to operatively engage to the glass 16 or the body 12 or the stand 22 and communicate vibration to the resin mixture within the defect 14, such as those sold by DIGIKEY of Thief River Falls, Minnesota.

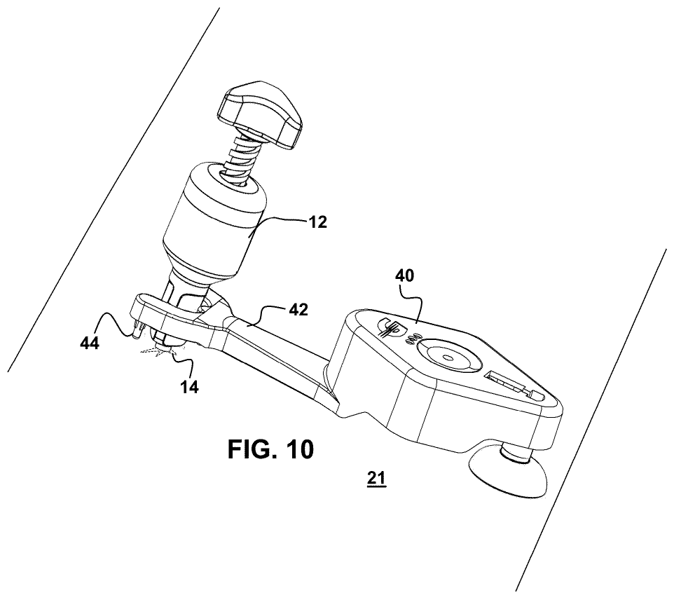

One currently favored configuration is shown in FIG. 10 wherein a vibrating component 40 is concurrently connected to both the injector 12 and the windshield glass exterior surface 21. As shown, a body 39 of the vibrating component 40 has a vibrator 41 operatively engaged. The vibrator 41 is powered by an onboard power supply, such as a battery, which may be recharged using a charging port 43. A connector 42 extends between the body 39 and an injector connection 45 at the distal end of the connector 42.

The injector connection 45 currently forms a frictional engagement with the body of the injector 12 using a C-shaped connection 45 having a first curved member 47 and a second curved member 49. The curved members 47 and 49 have a gap 51 therebetween through which a portion of the body of the injector 12 may be pushed whereupon the curved members 47 and 49 will momentarily flex outward and then contract to form a compressive frictional engagement to the injector 12. This compressive engagement is preferred as it helps to better communicate vibration from the vibrator 41, and it is easily removable.

Also positioned at the distal end of the connector 42, adjacent to the defect 14 in the glass 16 or windshield being repaired, is at least one vibrating post 44. The vibrating post 44 extends from the C-shaped connection 45 from at least one of the curved members 45. Preferably, at least a second vibrating post 44 extends from the second curved member 49 such that vibration is communicated from the vibrator 41 through the connector 42 to each of the vibrating posts 44 which are in contact with the outside surface of the glass 21 on opposing sides of the defect 14. Communicating vibration through two vibrating posts 44 contacting the outside surface of the glass 21 on opposing sides of the defect 14 has been shown in experimentation to work better to remove bubbles from the defect 14 and aid in a better communication of resin into the defect 14 than a single vibrating post. Additionally, a plurality of vibrating posts 44 has shown during experimentation to better maintain the particles 18 more evenly disbursed within the injected resin 11 and to maintain such even disbursement until the resin 11 and particles 18 are cured to a solid solution.

As noted, while not shown, the vibrating component 20 may also be mounted upon the stand 22 and will still communicate vibration to the glass 16 and defect 14 from the contact therewith by the injector. Still further, conventional windshield and glass 16 repairs employ a light emitter 15 which emits light in the proper frequency to cause a curing and hardening of the resin within the defect 14. Shown in FIG. 1, such light emitters are well known and are positioned generally upon the glass 16 during the time of the curing duration. The vibrating component 20 may also be positioned upon the light emitter 15 to communicate the vibrations to the glass 16, or in some modes, the vibrating component 20 may be separate and removably engaged directly to the glass 16 in an operative removable engagement which communicates the vibrations to the defect 14 area of the glass 16.

As noted, the vibrations communicated to the glass 16 from one or more positions will help in dislodging air bubbles within the voids of the defect 14 during a suction step where air and moisture are pulled from the defect 14. It should be noted that the frequency and strength of the vibrations, so communicated, may be adjusted to increase this dislodging effect. For example vibrations having a shorter frequency or one matching a structural dimension (width, length, depth) of the glass 16 or the defect 14 may be used to greater effect in dislodging air from the defect 14 and may also be used concurrently with applied suction to the defect 14 for enhanced removal of air and moisture.

FIG. 5 is a depiction of a typical windshield glass 16 sheet having an interior surface 19 opposite an exterior surface 21 and glass material and/or plastic there between. As shown, a defect 14 has been formed by an impact of an object with the exterior surface 21. The defect 14, as is well known, can include recesses formed into the exterior surface as well as cracks extending into the interior area of the glass 16 between the exterior surface 21 and interior surface 19. These cracks 25, as shown in FIG. 7, conventionally have a void between two side surfaces of the crack 25 in which the resin 11 is injected. As noted with conventional clear resin, there is no impediment to light reflecting from the two side surfaces forming the crack 25. However, using the mixture of resin 11 with particles 18 herein, formed to a solid solution, provides particles 18 in fixed positions which will intersect and help block or significantly reduce the brightness of reflected light 27 from these surfaces.

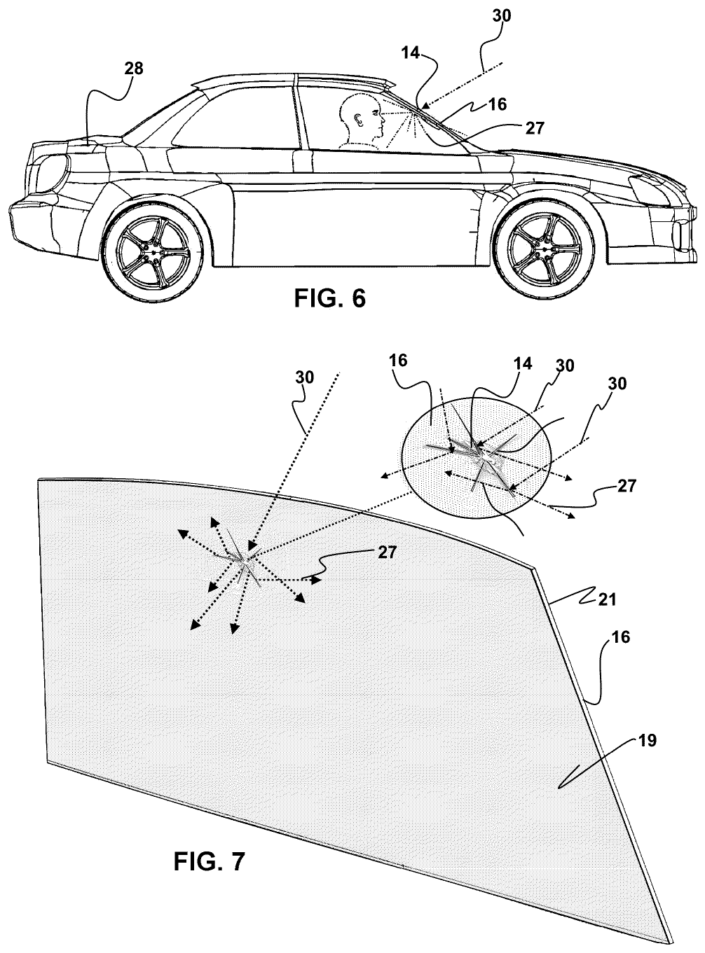

Shown in FIG. 6 is a graphic depiction of a conventional vehicle 28 having sunlight 30 communicating through the glass 16 forming a windshield. Also shown is the divergent paths of light reflections 27 of the sunlight 30 or in some cases artificial light, such as street lights, from cracks and other surfaces forming the defect 14 in a windshield which has not been repaired. An enlargement of such a windshield glass 16 is shown in FIG. 7. As depicted, sunlight 30 or artificial light striking the glass 16 and the defect 14 at an angle of incidence will generate reflected light 27 at multiple angles from the defect 14 depending on the angled surfaces formed by recesses and cracks 25 within the defect 14. This reflected light 27, in addition to being an irritation to drivers and passengers behind the windshield glass 16, can also impair the driving where the reflected light blinds or impairs the sight of the driver looking at the road ahead or a heads up display.

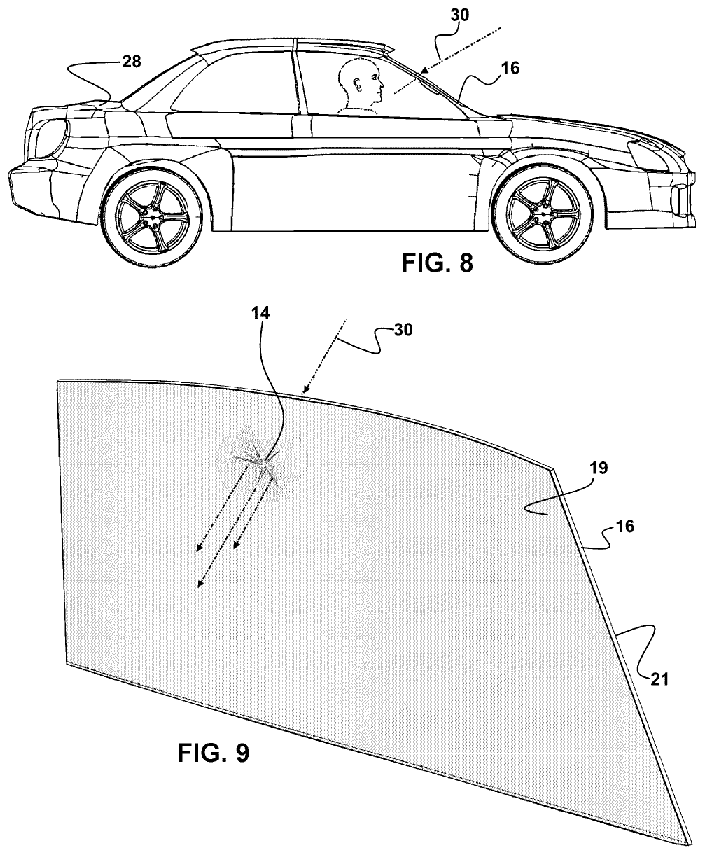

Shown in FIG. 8 is a depiction of a vehicle 28 having a windshield formed of a glass 16 sheet. As shown, incoming light 30 passes through the glass 16 and exits at angles affected primarily by the refractive quality of the glass 16 but without substantial reflected light 27. This is the normal operation of such windshield glass which is undamaged by defects 14. Using the repair resin 11 and particulate 18 suspended therein to repair the defect 14 and method herein, any reflected light from angular surfaces within a defect 14 of the glass of the vehicle as in FIG. 6 wherein the windshield is either prevented or significantly reduced in brightness. Such is shown in FIG. 9, which depicts a defect 14 which has been repaired with the solid solution of light curably resin 11 and particles 18 or particulate herein.

In a method of repair of such defects 14 in glass 16, such as a windshield, a resin 11 is mixed with particles 18 in a liquid solution mixture thereof. The resin chosen for the mixture may take into consideration the viscosity of the resin to work best with current temperature and the type of defect 14 being repaired in a conventional decision on the resin 11. The liquid solution of light curable resin and particulate is operatively positioned into an injector 12 and then the injector is operatively engaged with the defect in a windshield whereupon the liquid solution is injected into a defect 14 in the glass 16. Next, the liquid solution is exposed to a curing light emitted from a light emitter 15 which reacts to cure the liquid solution to form a solid solution thereof, including the resin and particles 18. Optionally, a vibrating component is actuated to vibrate and the vibrating component is engaged to vibrate the injector. Additionally, as an option the vibrating component is placed in a contact with the glass or windshield being repaired and vibrates the glass and the injected liquid solution until it cures to a solid solution.

While all of the fundamental characteristics and features of the curable resin with particulate therein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A resin material repairing defects in glass, comprising:
a light-curable resin;
particulate material mixed into said light curable resin to form a mixture of said light curable resin and said particulate disbursed therein;
said mixture of light curable resin and particulate forming a liquid solution for positioning into a resin injector for injection into a defect in glass;
said mixture of said light curable resin and said particulate forming said liquid solution when positioned within said defect being curable by light communicated thereto to thereby form a solid solution of cured light-curable resin and particulate within said defect whereby said particulate in said solid solution blocks reflections of sunlight emanating from said defect.

2. The resin material repairing defects in glass of claim 1 wherein said light-curable resin is one or a combination of light-curable resins, from a group of light-curable resins including, Benzyl Methacrylate, 2-Hydroxyethyl methacrylate, Octyl Acrylate, Decyl Acrylate, Acrylic Acid, and Isobornyl Acrylate.

3. The resin material repairing defects in glass of claim 1 wherein said particulate is formed of a particulate material which will not dissolve within the light curable-resin into which they are mixed.

4. The resin material repairing defects in glass of claim 2 wherein said particulate is formed of a particulate material which will not dissolve within the light curable-resin into which they are mixed.

5. The resin material repairing defects in glass of claim 3 wherein said particulate material is one or a combination of particulate materials from a group of particulate materials including graphene, carbon, carbon black, graphite, and ceramics.

6. The resin material repairing defects in glass of claim 4 wherein said particulate material is one or a combination of particulate materials from a group of particulate materials including graphene, carbon, carbon black, graphite, and ceramics.

7. The resin material repairing defects in glass of claim 3 wherein said particulate material within said mixture of said light curable resin and said particulate material is at a ratio of 0.04 to 20% of particulate material by total volume of the mixture of light-curable resin and particulate material.

8. The resin material repairing defects in glass of claim 4 wherein said particulate material within said mixture of said light curable resin and said particulate material is at a ratio of 0.04 to 20% of particulate material by total volume of the mixture of light-curable resin and particulate material.

9. The resin material repairing defects in glass of claim 5 wherein said particulate material within said mixture of said light curable resin and said particulate material is at a ratio of 0.04 to 20% of particulate material by total volume of the mixture of light-curable resin and particulate material.

10. The resin material repairing defects in glass of claim 6 wherein said particulate material within said mixture of said light curable resin and said particulate material is at a ratio of 0.04 to 20% of particulate material by total volume of the mixture of light-curable resin and particulate material.

11. A method for repairing defects in glass using the resin material of claim 1 comprising the steps of:
positioning said liquid solution of said mixture of light curable resin and particulate into an injector;
operatively engaging said injector with the defect in said windshield;
operating said injector to inject said liquid solution into said defect; and
communicating light from a curing light to said liquid solution within said defect to cure the liquid solution into a solid solution thereof.

12. A method for repairing defects in glass using the resin material of claim 5 comprising the steps of:
positioning said liquid solution of said mixture of light curable resin and particulate into an injector;
operatively engaging said injector with the defect in said windshield;
operating said injector to injected said liquid solution into said defect; and
communicating light from a curing light to said liquid solution within said defect to cure the liquid solution into a solid solution thereof.

13. A method for repairing defects in glass using the resin material of claim 9 comprising the steps of:
positioning said liquid solution of said mixture of light curable resin and particulate into an injector;
operatively engaging said injector with the defect in said windshield;
operating said injector to injected said liquid solution into said defect; and
communicating light from a curing light to said liquid solution within said defect to cure the liquid solution into a solid solution thereof.

14. The method for repairing defects in glass using the resin material of claim 11 additionally comprising the step of:
communicating vibration to the defect from a vibrating component.

15. The method for repairing defects in glass using the resin material of claim 12 additionally comprising the step of:
communicating vibration to the defect from a vibrating component.

16. The method for repairing defects in glass using the resin material of claim 13 additionally comprising the step of:
communicating vibration to the defect from a vibrating component.
